(19) United States
(12) Patent Application Publication
(10) Pub. No.: US 2024/0424631 A1
(43) Pub. Date: Dec. 26, 2024

(54) APPARATUSES AND METHODS FOR FINISHING THE EDGES OF GLASS SHEETS

(71) Applicant: CORNING INCORPORATED, Corning, NY (US)

(72) Inventors: James William Brown, The Villages, FL (US); Liang Chien Cheng, Taichung City (TW); Yi-Cheng Hsieh, Hsinchu (TW)

(21) Appl. No.: 18/710,347

(22) PCT Filed: Nov. 10, 2022
(86) PCT No.: PCT/US2022/049535

§ 371 Date: May 15, 2024

Related U.S. Application Data
(60) Provisional application No. 63/282,291, filed on Nov. 23, 2021.

(51) Int. Cl. B24B 9/10

(52) U.S. Cl. CPC B24B 9/10

(57) ABSTRACT

A method of finishing edges of glass sheets may include engaging an edge of a glass sheet with a groove of an edge finishing wheel as the edge finishing wheel is rotated with a motor. A working current of the motor may be monitored when the edge finishing wheel is engaged with the edge of the glass sheet. The working current may be indicative of a working torque of the motor. The method may further include determining if the working torque of the motor is greater than an upper threshold torque value corresponding to a maximum groove depth. A blade of a cutting head is engaged with an outer diameter of the edge finishing wheel when the working torque of the motor is greater than the upper threshold torque value thereby shaving material from the outer diameter of the edge finishing wheel and decreasing the working torque of the motor.

### CROSS-REFERENCE TO RELATED APPLICATIONS

This application claims the benefit of priority under 35 U.S.C. § 119 of U.S. Provisional Application Ser. No. 63/282,291, filed on Nov. 23, 2021, the content of which is relied upon and incorporated herein by reference in its entirety.

### FIELD

The present specification generally relates to methods and apparatuses for finishing the edges of glass sheets.

### TECHNICAL BACKGROUND

In glass sheet manufacturing processes, the edges of the glass sheets may be finished, such as by grinding, polishing, and/or cleaning, to improve the quality of the glass sheets. The final step of the finishing processes may utilize glass edge finishing wheels to polish the edges of the glass sheets and remove particulates and/or debris from the edges of the glass sheets. During this step, the edges of the glass sheets are inserted into a groove of a rotating glass edge finishing wheel, whereby imperfections and/or particulates are removed from the edges of the glass sheets. However, the glass edge finishing wheels utilized in this final step are often made of soft materials, such that the wheels are quickly worn during use, resulting in insufficient edge finishing over time.

Accordingly, a need exists for alternative methods and apparatuses for finishing the edges of glass sheets that prolong the service life of the glass edge finishing wheels.

### SUMMARY

A first aspect A1 includes a method of finishing edges of glass sheets, the method comprising: engaging an edge of a glass sheet with a groove of an edge finishing wheel as the edge finishing wheel is rotated with a motor; monitoring a working current of the motor when the edge finishing wheel is engaged with the edge of the glass sheet, wherein the working current is indicative of a working torque of the motor; determining if the working torque of the motor is greater than an upper threshold torque value corresponding to a maximum groove depth; and engaging a blade of a cutting head with an outer diameter of the edge finishing wheel when the working torque of the motor is greater than the upper threshold torque value, thereby shaving material from the outer diameter of the edge finishing wheel and decreasing the working torque of the motor.

A second aspect A2 includes the method of the first aspect A1, wherein: the upper threshold torque value is an upper threshold torque ratio corresponding to the maximum groove depth; and determining if the working torque of the motor is greater than the upper threshold torque ratio comprises: determining a working torque ratio of the motor, wherein the working torque ratio=(the working current of the motor/a maximum current of the motor)×100; determining a difference between the working torque ratio and a baseline torque ratio of the motor, wherein the baseline torque ratio=(a baseline current of the motor/the maximum current of the motor)×100; and comparing the difference between the working torque ratio and the baseline torque ratio to the upper threshold torque ratio.

A third aspect A3 includes the method of any of aspects A1 through A2, wherein the upper threshold torque ratio is within a range from 48% to 52%.

A fourth aspect A4 includes the method of any of aspects A1 through A3 further comprising directing liquid onto the blade of the cutting head and the edge finishing wheel when the blade of the cutting head is engaged with the outer diameter of the edge finishing wheel.

A fifth aspect A5 includes method of any of aspects A1 through A4 further comprising collecting the liquid and debris from the shaving material from the outer diameter of the edge finishing wheel in a collection trough.

A sixth aspect A6 includes the method of any of aspects A1 through A5, wherein a debris shield is disposed proximate the edge finishing wheel and oriented to direct liquid and debris projected from the edge finishing wheel into the collection trough.

A seventh aspect A7 includes the method of any of aspects A1 through A6 further comprising applying vacuum to the collection trough to evacuate the liquid and debris from the collection trough.

An eighth aspect A8 includes the method of any of aspects A1 through A7 further comprising directing the liquid and debris from the collection trough to a waste recovery bin.

A ninth aspect A9 includes the method of any of aspects A1 through A8, wherein the edge finishing wheel comprises abrasive particles embedded in a resin matrix.

A tenth aspect A10 includes the method of any of aspects A1 through A9, wherein the edge finishing wheel comprises a plurality of grooves.

An eleventh aspect A11 includes the method of any of aspects A1 through A10, wherein a depth of the plurality of grooves is greater than or equal to 0.3 mm and less than or equal to 0.6 mm.

A twelfth aspect A12 includes the method of any of aspects A1 through A11, wherein a pitch of the plurality of grooves is less than or equal to 1.5 mm.

A thirteenth aspect A13 includes an edge finishing apparatus for finishing an edge of a glass sheet, the edge finishing apparatus comprising: a finishing wheel assembly comprising an edge finishing wheel rotatably coupled to a motor, the edge finishing wheel comprising a plurality of grooves for engaging with the edge of the glass sheet; a wheel dressing assembly comprising a cutting head mechanically coupled to an actuator; and a controller communicatively coupled to the motor of the finishing wheel assembly and the actuator of the wheel dressing assembly, the controller comprising a processor and a non-transitory memory storing computer readable and executable instructions which, when executed by the processor, cause the processor to: receive a signal from the motor indicative of a working torque of the motor; determine if the working torque of the motor is greater than an upper threshold torque value corresponding to a maximum groove depth; and initiate a wheel dressing operation when the working torque of the motor is greater than the upper threshold torque value, wherein the controller initiates the wheel dressing operation by actuating the actuator of the wheel dressing assembly to engage a blade of the cutting head with the edge finishing wheel.

A fourteenth aspect A14 includes the edge finishing apparatus of aspect A13, wherein: the upper threshold torque value is an upper threshold torque ratio corresponding to the maximum groove depth; and the processor determines if the working torque of the motor is greater than the upper threshold torque ratio by: determining a working torque ratio of the motor based on the signal indicative of the working torque of the motor, wherein the working torque ratio=(a working current of the motor/a maximum current of the motor)×100; and determining a difference between the working torque ratio and a baseline torque ratio of the motor, wherein the baseline torque ratio=(a baseline current of the motor/the maximum current of the motor)×100.

A fifteenth aspect A15 includes the edge finishing apparatus of any of Aspects A13 through A14, wherein the upper threshold torque ratio is within a range from 48% to 52%.

A sixteenth aspect A16 includes the edge finishing apparatus of any of Aspects A13 through A15, wherein: the edge finishing apparatus further comprises a nozzle positioned to direct liquid onto the cutting head and the edge finishing wheel; and initiating the wheel dressing operation comprises actuating at least one valve operatively associated with the nozzle such that the liquid is directed onto the cutting head and the edge finishing wheel.

A seventeenth aspect A17 includes the edge finishing apparatus of any of Aspects A13 through A16, further comprising a collection trough disposed below the edge finishing wheel and the cutting head, the collection trough arranged to collect debris and liquid during the wheel dressing operation.

An eighteenth aspect A18 includes the edge finishing apparatus of any of Aspects A13 through A17, further comprising: a vacuum system fluidly coupled to the collection trough with a drain line; and a waste recovery bin coupled to the drain line, wherein initiating the wheel dressing operation comprises actuating the vacuum system fluidly coupled to the collection trough to evacuate debris and liquid from the collection trough to the waste recovery bin.

A nineteenth aspect A19 includes the edge finishing apparatus of any of Aspects A13 through A18, further comprising a debris shield disposed proximate the edge finishing wheel and oriented to directed liquid and debris projected from the edge finishing wheel during the wheel dressing operation into the collection trough.

A twentieth aspect A20 includes the edge finishing apparatus of any of Aspects A13 through A19, wherein: a depth of the plurality of grooves is greater than or equal to 0.3 mm and less than or equal to 0.6 mm; and a pitch of the plurality of grooves is less than or equal to 1.5 mm.

Additional features and advantages of the methods and apparatuses described herein will be set forth in the detailed description that follows, and in part will be readily apparent to those skilled in the art from that description or recognized by practicing the embodiments described herein, including the detailed description, which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1A schematically depicts an edge finishing wheel engaged with an edge of a glass sheet and the forces acting on the edge of the glass sheet;

FIG. 1B schematically depicts an edge of a glass sheet engaged with a new (un-worn) groove of an edge finishing wheel and the resulting forces acting on the edge of the glass sheet;

FIG. 1C schematically depicts an edge of a glass sheet engaged with a used (worn) groove of an edge finishing wheel and the resulting forces acting on the edge of the glass sheet;

FIG. 2 schematically depicts an edge finishing apparatus for finishing the edges of glass sheets, according to one or more embodiments shown and described herein;

FIG. 3 schematically depicts a cross-section of an edge finishing wheel according to one or more embodiments shown and described herein;

FIG. 4 schematically depicts the edge finishing apparatus of FIG. 2 during a wheel dressing operation, according to one or more embodiments shown and described herein;

FIG. 5 is a flow chart of a method for initiating a wheel dressing operation on an edge finishing wheel of an edge finishing apparatus, according to one or more embodiments shown and described herein; and

FIG. 6 is a partial flow chart of an alternative method for initiating a wheel dressing operation on an edge finishing wheel of an edge finishing apparatus, according to one or more embodiments shown and described herein.

### DETAILED DESCRIPTION

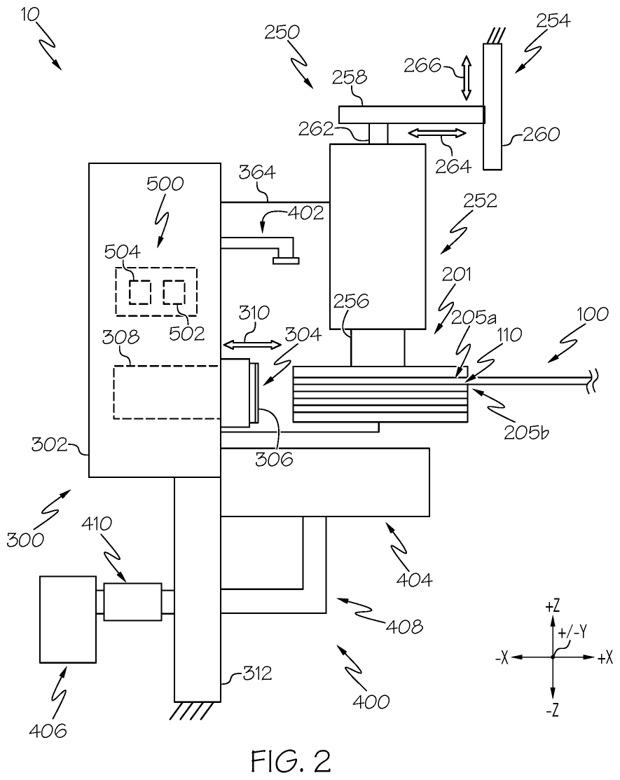

Reference will now be made in detail to embodiments of apparatuses and methods for finishing the edges of glass sheets, examples of which are illustrated in the accompanying drawings. Whenever possible, the same reference numerals will be used throughout the drawings to refer to the same or like parts. One embodiment of an apparatus for finishing the edges of glass sheets is depicted in FIG. 2. A method of finishing the edges of glass sheets with the apparatus may generally include engaging an edge of a glass sheet with a groove of an edge finishing wheel as the edge finishing wheel is rotated with a motor. A working current of the motor may be monitored when the edge finishing wheel is engaged with the edge of the glass sheet. The working current may be indicative of a working torque of the motor. The method may further include determining if the working torque of the motor is greater than an upper threshold torque value corresponding to a maximum groove depth. A blade of a cutting head is engaged with an outer diameter of the edge finishing wheel when the working torque of the motor is greater than the upper threshold torque value thereby shaving material from the outer diameter of the edge finishing wheel and decreasing the working torque of the motor. Various embodiments of apparatuses for finishing the edges of glass sheets and methods of using the same will be described herein in further detail with specific reference to the appended drawings.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

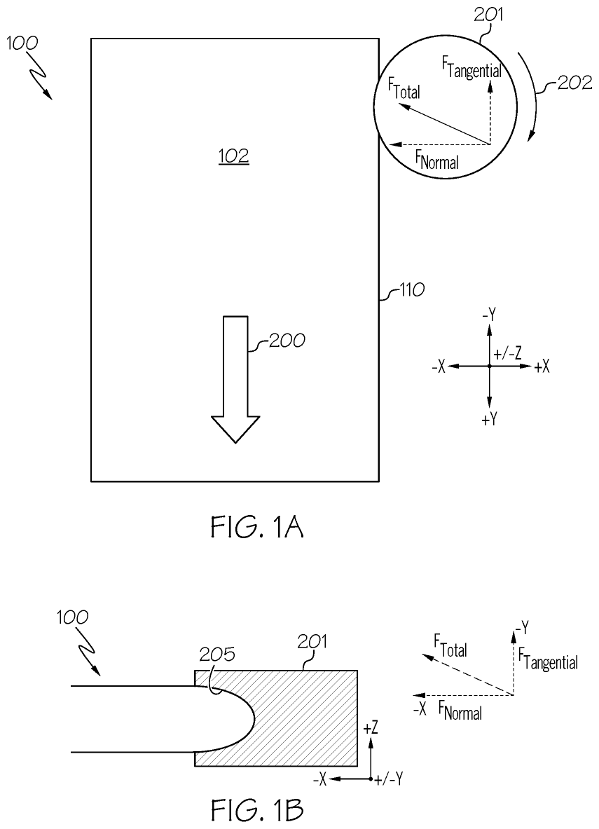

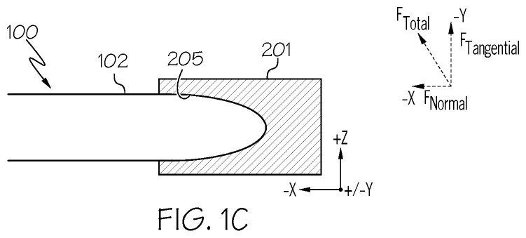

As noted herein, the edges of glass sheets may be finished using a series of grinding, polishing, and cleaning processes. These processes utilize rotating glass edge finishing wheels engaged with the edges of the glass sheets. An example of an edge finishing process is schematically depicted in FIG. 1A in which a rotating edge finishing wheel 201 is in contact with an edge 110 of a glass sheet 100 as the glass sheet 100 is translated in the direction indicated by arrow 200 (i.e., in the +Y direction of the coordinate axes shown in FIG. 1A) and the edge finishing wheel 201 is rotated in the direction indicated by arrow 202 in the X-Y plane of the coordinate axes depicted in FIG. 1A. The glass edge finishing wheels 201 utilized in the final step of edge finishing processes are often made of soft materials, generally softer than the finishing wheels used for the initial grinding and polishing steps. As such, the glass edge finishing wheels utilized in the final finishing step often wear quickly. As the grooves of the glass edge finishing wheels deepen from wear, the forces acting on the edges of the glass sheets diminish, which results in insufficient edge finishing over time and necessitates replacement of the edge finishing wheels. Replacement of the edge finishing wheels results in process down time, decreasing glass sheet manufacturing throughput and adding manufacturing costs in terms of lost production time and increased material costs.

It has now been determined that the root cause of the diminished forces of the edge finishing wheel 201 acting on the edge 110 of the glass sheet 100 relate to the manner in which forces from the edge finishing wheel 201 are distributed on the glass sheet 100 as the groove of the edge finishing wheel 201 deepens over time. In particular, the total force (F-Total) incident on the edge 110 of the glass sheet 100 from the edge finishing wheel 201 includes a normal force component (F_{Normal}, acting in the −X direction of the coordinate axes depicted in FIG. 1A) orthogonal to the edge 110 and a tangential force component (F Tangential, acting in the −Y direction of the coordinate axes depicted in FIG. 1A) tangent (e.g., parallel) to the edge 110, as depicted in FIG. 1A. The normal force component F_{Normal} acting directly on the edge 110 of the glass sheet 100 is primarily responsible for the polishing and/or cleaning that occurs on the edge 110 of the glass sheet 100.

Referring collectively to FIGS. 1A and 1B, FIG. 1B depicts the engagement of the edge finishing wheel 201 with the edge 110 of the glass sheet 100 when the edge finishing wheel 201 is new and the groove 205 in the edge finishing wheel 201 is shallow (i.e., not worn). FIG. 1B also graphically depicts the magnitude of the normal force component F_{Normal} acting in the −X direction of the coordinate axes depicted in FIG. 1B and the magnitude of the tangential force component F_{Tangential} acting in the −Y direction of the coordinate axes depicted in FIG. 1B. With the edge finishing wheel 201 in new condition, the normal force component F_{Normal} of the total force F_{Total} acting on the edge 110 of the glass sheet 100 in the −X direction is greater than the tangential force component F_{Tangential} acting in the −Y direction and the edge finishing wheel 201 efficiently cleans and/or polishes the edge 110 of the glass sheet 100.

Referring now to FIGS. 1A and 1C collectively, FIG. 1C depicts the engagement of the edge finishing wheel 201 with the edge 110 of the glass sheet 100 when the edge finishing wheel 201 is in a worn condition and the groove 205 in the edge finishing wheel 201 is deeper than shown in FIG. 1B. FIG. 1C also graphically depicts the magnitude of the normal force component F_{Normal} acting in the −X direction of the coordinate axes depicted in FIG. 1C and the magnitude of the tangential force component F_{Tangential} acting in the −Y direction of the coordinate axes depicted in FIG. 1C. As the edge finishing wheel 201 wears over time, the groove 205 of the edge finishing wheel 201 becomes deeper, as depicted in FIG. 1C. The deeper groove in the edge finishing wheel 201 results in increased contact between the edge finishing wheel 201 and the surface(s) 102 of the glass sheet 100 which, in turn, increases the tangential force component F-Tangential of the total force F_{Total} acting on the glass sheet 100 in the −Y direction of the coordinate axes depicted in FIG. 1C while reducing the normal force component F_{Normal} acting in the −X direction, as depicted in FIG. 1C. The reduction in the normal force component F_{Normal} diminishes the effectiveness of the cleaning and/or polishing performed by the edge finishing wheel 201 on the edge 110 of the glass sheet 100, thereby reducing the quality of the finished glass sheet and/or necessitating additional steps to complete the finishing of the edge 110 of the glass sheet 100. In addition, increased contact between the surface(s) 102 of the glass sheet 100 and the edge finishing wheel 201 may damage the surface(s) 102 of the glass sheet 100, such as by scratching or the like, further diminishing the quality of the glass sheet 100, which may lead to the glass sheet 100 being discarded as waste glass. In both situations, the wear of the edge finishing wheel 201 may decrease manufacturing efficiencies and, in some circumstances, increase manufacturing costs.

The embodiments disclosed herein relate to methods and apparatuses for mitigating the effects of edge finishing wheel wear during the manufacture and finishing of glass sheets.

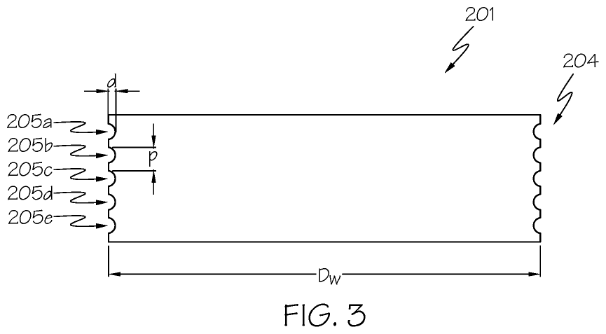

Referring now to FIG. 2, an edge finishing apparatus 10 for finishing the edge(s) 110 of a glass sheet 100 is schematically depicted according to one or more embodiments shown and described herein. The edge finishing apparatus 10 generally comprises a finishing wheel assembly 250, a wheel dressing assembly 300, a debris recovery system 400, and a controller 500. The various components of the edge finishing apparatus 10 will be described in further detail herein with specific reference to FIGS. 2 and 3.

In the embodiments described herein, the finishing wheel assembly 250 of the edge finishing apparatus comprises an edge finishing wheel 201 and a motor 252. In embodiments, the finishing wheel assembly 250 may optionally include a multi-axis positioning stage 254. The edge finishing wheel 201 is rotatably coupled to an armature 256 of the motor 252 to facilitate rotation of the edge finishing wheel 201 in a plane parallel to the X-Y plane of the coordinate axes depicted in FIG. 2.

In embodiments in which the finishing wheel assembly 250 includes a multi-axis positioning stage 254, the multi-axis positioning stage 254 may be coupled to the motor 252 through linkage 262. The multi-axis positioning stage 254 may include two or more linear actuators, such as linear actuators 258 and 260, to facilitate adjusting the position of the motor 252 and attached edge finishing wheel 201 along at least two axes. For example, in the embodiment depicted in FIG. 2, the multi-axis positioning stage 254 includes a first linear actuator 258 to facilitate movement of the motor 252 and the attached edge finishing wheel 201 relative to the edge 110 of the glass sheet 100 in the +/−X direction of the coordinate axes depicted in FIG. 2, as indicated by arrow 264. The multi-axis positioning stage 265 may also include a second linear actuator 260 orthogonal to the first linear actuator 258 to facilitate movement of the motor 252 and the attached edge finishing wheel 201 relative to the glass sheet 100 in the +/−Z direction of the coordinate axes depicted in FIG. 2, as indicated by arrow 266. While not depicted in FIG. 2, it should be understood that the multi-axis positioning stage 265 may optionally include a third linear actuator orthogonal to the first and second linear actuators 258, 260 to facilitate movement of the motor 252 and the attached edge finishing wheel 201 relative to the glass sheet 100 in the +/−Y direction of the coordinate axes depicted in FIG. 2. When included, the multi-axis positioning stage 254 may be used, for example, to index the edge finishing wheel 201 relative to the edge 110 of the glass sheet 100 to accommodate for changes in the dimensions of the edge finishing wheel following wear and subsequent (re) dressing of the edge finishing wheel 201 as a result of wear, as will be described in further detail herein. The multi-axis positioning stage 254 may be used, for example, to index the edge finishing wheel 201 relative to the edge 110 of the glass sheet 100 such that the glass sheet 100 may be positioned in a specific one of a series of grooves formed in the outer diameter of the edge finishing wheel 201.

Referring now to FIG. 3, a cross-section of one embodiment of an edge finishing wheel 201 is schematically depicted. The edge finishing wheel 201 generally comprises abrasive particles, such as silicon carbide particles or the like, embedded in a resin matrix. As one example, the edge finishing wheel 201 may be constructed from a Scotch-Brite™ Molded Wheel XR-WM (DLO Wheel) from 3M Abrasive Systems. However, it should be understood that other types of wheels and other materials for the edge finishing wheel are contemplated and possible.

As depicted in FIG. 3, the edge finishing wheel 201 may have an initial outer diameter D_{W} (i.e., the diameter D_{W} is the diameter of the edge finishing wheel prior to use for edge finishing). In embodiments, the initial outer diameter D_{W} may be, for example, 150 mm. However, it should be understood that edge finishing wheels 201 having larger or smaller initial outer diameters are contemplated and possible. The edge finishing wheel 201 may further comprise a series of grooves 205, such as grooves 205a, 205b, 205c, 205d, and 205d formed in the edge 204 of the edge finishing wheel 201. During a glass edge finishing operation, an edge of a glass sheet is received in one of the grooves 205a, 205b, 205c, 205d as the edge finishing wheel 201 is rotated to facilitate, for example, polishing and cleaning of the edge of the glass sheet with the edge finishing wheel 201. In the embodiment of the edge finishing wheel 201 depicted in FIG. 3, a total of five grooves 205a, 205b, 205c, 205d are depicted for purposes of illustration. However, it should be understood that the edge finishing wheel 201 may contain more than five grooves or less than five grooves. For example, in embodiments the edge finishing wheel 201 may comprise 10 grooves, 15 grooves, or even 20 or more grooves. As shown in FIG. 3, the grooves 205 have a pitch P. In embodiments of the edge finishing wheels 201 described herein, the pitch P of the grooves may be less than 2 mm, such as less than 1.9 mm, less than or equal to 1.8 mm, less than or equal to 1.7 mm, less than or equal to 1.6 mm, less than or equal to 1.5 mm, less than or equal to 1.4 mm, less than or equal to 1.3 mm, less than or equal to 1.2 mm, less than or equal to 1.1 mm, or even less than or equal to 1 mm. The grooves 205a, 205b, 205c, 205d have depth d from the outer diameter of the edge finishing wheel 201. In embodiments, the groove depth d of a new (un-worn) edge finishing wheel 201 may be, for example and without limitation, greater than or equal to 0.3 mm and less than or equal to 0.6 mm.

Referring again to FIG. 2, the wheel dressing assembly 300 generally comprises a housing 302 supporting a cutting head 304 comprising a blade 306. The cutting head 304 and blade 306 are utilized to dress (e.g., shave) the outer diameter of a worn edge finishing wheel 201 to restore (i.e., reduce) the groove depth of the worn edge finishing wheel 201, thereby improving the finishing performance of the edge finishing wheel 201, as will be described in further detail herein. The housing 302 of the wheel dressing assembly 300 may be supported on a stanchion 312 such that the cutting head 304 and blade 306 are located in proximity to the outer diameter of the edge finishing wheel 201. The wheel dressing assembly 300 also includes an actuator 308 disposed in the housing 302. The actuator 308 may be, for example, a linear actuator. The actuator 308 is mechanically coupled to the cutting head 304 to facilitate extending and retracting the cutting head 304 relative to the housing 302, as indicated by arrow 310, which, in turn, facilitates engaging the blade 306 of the cutting head 304 with the edge finishing wheel 201 to periodically dress the edge finishing wheel 201. For example, the actuator 308 may extend the cutting head 304 such that the blade 306 of the cutting head 304 engages with the perimeter of the edge finishing wheel 201 and shaves a portion of the perimeter from the edge finishing wheel 201 which, in turn, decreases the diameter of the edge finishing wheel 201 from an initial outer diameter D_{W} to a shaved outer diameter Ds which decreases the depth of the grooves formed in the outer diameter of the edge finishing wheel 201. As illustrated in FIG. 2, the wheel dressing assembly 300 is generally located on an end of a diameter of the edge finishing wheel 201 opposite from the glass sheet 100 such that any risk of the glass sheet 100 interacting with the wheel dressing assembly 300, or any debris generated by the wheel dressing assembly 300, is mitigated.

Still referring to FIG. 2, the edge finishing apparatus may also comprise a debris recovery system 400. The debris recovery system 400 may include a nozzle 402 positioned to supply a liquid, such as water, to the blade 306 of the cutting head 304 and the edge finishing wheel 201 when the blade 306 is engaged with the edge finishing wheel 201. In the embodiment depicted in FIG. 2, the nozzle 402 is positioned above both the cutting head 304 and the edge finishing wheel 201 such that liquid from the nozzle is directed onto cutting head 304 and the edge finishing wheel 201 from above to flush any debris generated during a wheel dressing operation downward and away from the edge finishing wheel 201. In embodiments, the nozzle 402, and related control valves (not depicted) operatively associated with the nozzle 402, may be configured to automatically supply liquid to the blade 306 of the cutting head 304 and the edge finishing wheel 201 when the cutting head 304 is extended towards the edge finishing wheel 201. In practice, the liquid provided to the blade 306 from the nozzle 402 functions to cool the blade 306 of the cutting head 304 and also flushes debris (such as shavings) from the edge finishing wheel 201 as the edge finishing wheel 201 is dressed by the blade 306 of the cutting head 304.

In embodiments, the debris recovery system 400 may further include a collection trough 404 and a waste recovery bin 406 to collect and remove debris generated from the edge finishing wheel 201 during dressing of the edge finishing wheel 201 by the blade 306 of the cutting head 304. In the embodiments described herein, the collection trough 404 is positioned below the edge finishing wheel 201 and the cutting head 304 and is fluidly coupled to the waste recovery bin 406 by drain line 408. Optionally, a vacuum system 410 may be coupled to the drain line 408 to pull vacuum on the drain line 408 and thereby facilitate movement of debris from the collection trough 404 to the waste recovery bin 406 through the drain 408.

In operation, liquid emitted from the nozzle 402 onto the blade 306 of the cutting head 304 and the edge finishing wheel 201 as the edge finishing wheel 201 is dressed by the blade 306 is collected in the collection trough 404, in addition to any debris flushed from the edge finishing wheel 201. The liquid and any debris collected in the collection trough 404 are directed into the waste recovery bin 406, either by gravity or by the vacuum system 410, and contained in the waste recovery bin 406 for later processing and/or disposal.

In embodiments, the debris recovery system 400 may optionally comprise a debris shield 364. The debris shield 364 may be, for example and without limitation, coupled to the housing 302 of the wheel dressing assembly 300 and positioned relative to the edge finishing wheel 201 such that debris generated while dressing the edge finishing wheel 201 with the blade 306 of the cutting head 304 is incident on and contained by the debris shield 364, thereby preventing the debris from contaminating other areas of the edge finishing apparatus 10 and/or damaging glass sheets 100 finished with the edge finishing apparatus 10. For example, engagement of the blade 306 of the cutting head 304 with the rotating edge of finishing wheel 201 during dressing of the edge finishing wheel 201 creates particulate debris that mixes with the liquid emitted by the nozzle 402. The debris and liquid may be projected by the edge finishing wheel 201 in the direction of rotation of the edge finishing wheel 201. The debris shield 364 is positioned such that the projected debris and liquid are incident on, and thereby contained by, the debris shield 364. The debris shield 364 is also positioned such that the debris and liquid incident on the debris shield 364 flows down the debris shield 364 and into the collection trough 404 where the debris and liquid are directed into the waste recovery bin 406 for later processing and/or disposal.

Still referring to FIG. 2, the edge finishing apparatus 10 further comprises a controller 500. In the embodiment of the edge finishing apparatus 10 depicted in FIG. 2, the controller 500 is positioned in the housing 302 of the wheel dressing assembly 300. However, it should be understood that other locations for the controller 500 are contemplated and possible. For example and without limitation, the controller 500 may be a stand-alone unit separate and apart from each of the finishing wheel assembly 250, the wheel dressing assembly 300, and the debris recovery system 400.

In the embodiments described herein, the controller 500 comprises a processor 502 communicatively coupled to a non-transitory memory 504 storing computer readable and executable instructions which, when executed by the processor 502, facilitate the operation of the edge finishing apparatus 10. In particular, the computer readable and executable instructions may facilitate a wheel dressing operation by the edge finishing apparatus 10 to improve or restore the efficacy of the edge finishing performed by the edge finishing apparatus 10. In embodiments, the controller 500 is communicatively coupled to the motor 252 of the finishing wheel assembly 250, the actuator 308 of the wheel dressing assembly 300, and one or more valves (not depicted) operatively associated with the nozzle 402 of the debris recovery system 400. The controller may also be communicatively coupled to the vacuum system 410 of the debris recovery system 400 and the linear actuators 258, 260 of the multi-axis positioning stage 254 of the finishing wheel assembly 250 (when the finishing wheel assembly 250 includes the multi-axis positioning stage 254).

In embodiments, the controller 500 and associated processor 502 are operable to receive signals from the motor 252 of the finishing wheel assembly 250 indicative of the operating current of the motor 252. In the embodiments described herein, the operating current of the motor 252 is, itself, indicative of the torque of the motor 252. The controller 500 and associated processor 502 may also be operable to send control signals to the actuator 308 of the wheel dressing assembly 300, and one or more valves (not depicted) operatively associated with the nozzle 402 of the debris recovery system 400 based on and responsive to the signals received from the motor 252 indicative of the operating current of the motor 252. The controller 500 and associated processor 502 may also be operable to send control signals to the vacuum system 410 of the debris recovery system 400 and the linear actuators 258, 260 of the multi-axis positioning stage 254 of the finishing wheel assembly 250 (when the finishing wheel assembly 250 includes the multi-axis positioning stage 254) based on and responsive to the signals received from the motor 252 indicative of the operating current of the motor 252.

For example, when the edge finishing wheel 201 of the finishing wheel assembly 250 is rotated by the motor 252 but is not under an applied load (i.e., when the edge finishing wheel 201 is not engaged with an edge 110 of a glass sheet 100), the operating current of the motor 252 may have a baseline value (i.e., the “baseline current” value) which generally corresponds to the baseline torque of the motor 252 (i.e., the “baseline torque” value). However, when the edge finishing wheel 201 of the finishing wheel assembly 250 is rotated by the motor 252 and is under an applied load, such as when the edge finishing wheel is engaged with an edge 110 of a glass sheet 100, the operating current of the motor 252 under the applied load may be greater than the baseline current value and this value of the operating current under load (i.e., the “working current” value) generally corresponds to the torque of the motor 252 under the applied load (i.e., the “working torque” value). In embodiments, the computer readable and executable instruction set stored in the memory 504 of the controller 500 utilizes the working current values, either alone or in conjunction with the baseline current value, to initiate a wheel dressing operation whereby the cutting head 304 of the wheel dressing assembly 300 is engaged with the edge finishing wheel 201 to dress or shave the edge finishing wheel 201 to control (i.e., reduce) the depth of the grooves of the edge finishing wheel 201 and thereby improve and/or restore the efficacy of the edge finishing operation.

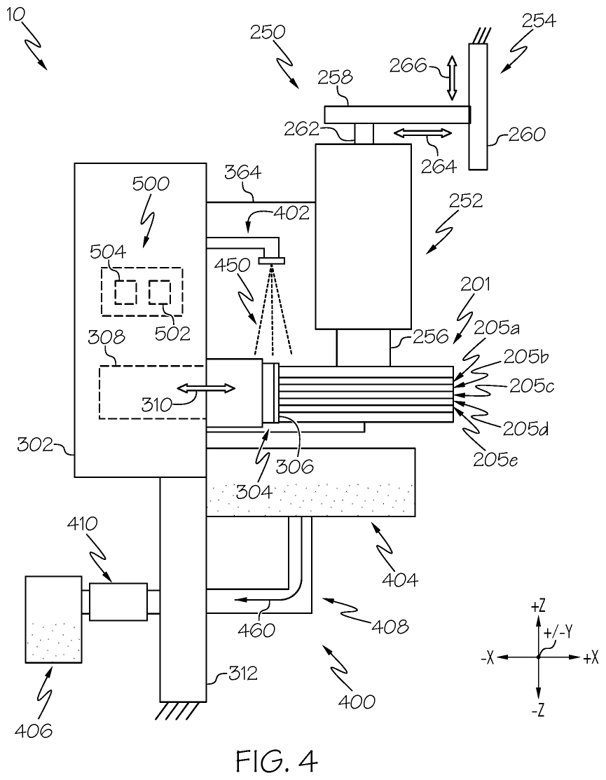

Referring now to FIG. 4, FIG. 4 schematically depicts the edge finishing apparatus 10 during a wheel dressing operation initiated by the controller 500. Based on the signals received from the motor 252 indicative of the current of the motor 252, the processor 502 of the controller 500 executes the computer readable and executable instruction set stored in the memory 504 of the controller 500 to initiate a wheel dressing operation in which the blade 306 of the cutting head 304 is engaged with the edge finishing wheel 201 and liquid 450 is directed onto the blade 306 of the cutting head 304 and the edge finishing wheel 201 with the nozzle 402. For example, the processor 502 of the controller 500 may send control signals to the actuator 308 coupled to the cutting head 304 causing the actuator 308 to advance the cutting head 304 towards the edge finishing wheel 201, thereby engaging the blade 306 of the cutting head 304 with the edge finishing wheel 201 to dress the edge finishing wheel 201, thereby reducing the depth of the grooves 205a, 205b, 205c, 205d, 205e of the edge finishing wheel 201. Simultaneously, the processor 502 of the controller 500 sends control signals to the one or more valves (not depicted) operatively associated with the nozzle 402 causing the valve to open, thereby allowing a flow of liquid 450 to emit from the nozzle 402 and onto the blade 306 and the edge finishing wheel 201. In embodiments, the processor 502 of the controller 500 may also send control signals to the vacuum system 410, thereby activating the vacuum system 410 such that liquid and debris collected in the collection trough 404 is evacuated into the waste recovery bin 406 during the wheel dressing operation, as indicated by arrow 460.

In embodiments, the wheel dressing operation may be designed to remove a predetermined amount of material from the outer diameter of the edge finishing wheel 201. For example, the controller 500 of the edge finishing apparatus 10 may be programmed to incrementally advance the cutting head 304 of the wheel dressing assembly 300 by a predetermined amount for each wheel dressing operation initiated by the controller 500 such that the same amount of material is removed from the outer diameter of the edge finishing wheel 201 with each consecutive wheel dressing operation initiated. In embodiments, for example, the controller 500 of the edge finishing apparatus may be programmed to shave 40 micrometers of material from the outer diameter of the edge finishing wheel 201 with each initiated wheel dressing operation. As such, the controller 500 may be programmed to advance the cutting head 304 by an additional 40 micrometers for each consecutive wheel dressing operation initiated by the controller 500 to account for the reduced outer diameter of the edge finishing wheel 201.

Once the wheel dressing operation is completed (e.g., after a predetermined number of revolutions of the edge finishing wheel 201 have occurred following engagement of the blade 306 with the edge finishing wheel 201 or after an elapsed time following engagement of the blade 306 with the edge finishing wheel 201), the processor of the controller 500 sends control signals to the actuator 308 coupled to the cutting head 304 causing the actuator 308 to retract the cutting head 304 and blade 306 from the edge finishing wheel 201, thereby disengaging the blade 306 of the cutting head 304 from the edge finishing wheel 201. Thereafter, the processor 502 of the controller 500 sends control signals to the one or more valves (not depicted) operatively associated with the nozzle 402 causing the valve to close thereby discontinuing the flow of liquid 450 from the nozzle 402. The processor 502 of the controller 500 may also send control signals to the vacuum system 410 deactivating the vacuum system 410.

In some embodiments, after completion of the of the wheel dressing operation, the processor of the controller 500 may send signals to the linear actuators 258, 260 of the multi-axis positioning stage 254 of the finishing wheel assembly 250 (when the finishing wheel assembly 250 includes the multi-axis positioning stage 254) to adjust the position of the motor 252 and attached edge finishing wheel 201 relative to the edge 110 of the glass sheet 100 based on the new diameter of the edge finishing wheel 201 following the wheel dressing operation.

As noted hereinabove with respect to FIGS. 1A-1C, as a groove 405 in an edge finishing wheel 201 wears and becomes deeper, the force distribution on the edge 110 of the glass sheet 100 changes. In particular, the tangential force component F_{Tangential} of the total force F_{Total} acting on the glass sheet 100 due to contact with the edge finishing wheel 201 increases as more area of the surface(s) 102 of the glass sheet 100 are in contact with the groove of the edge finishing wheel 201 due to deepening of the groove. Simultaneously, the normal force component F_{Normal} of the total force F_{Total} acting on the glass sheet 100 decreases, reducing the efficacy of the glass edge finishing operation. In practice, the increased contact between the surface(s) 102 of the glass sheet 100 causes the working torque of the motor to increase. That is, the working torque of the motor may increase as the depth of the groove increases. As such, in embodiments, the value of the working torque of the motor 252 may be utilized by the controller 500 of the edge finishing apparatus as an indicium to initiate a wheel dressing operation, whereby the depth of the grooves in the edge finishing wheel 201 is reduced and the efficacy of the glass edge finishing operation performed by the edge finishing wheel 201 is restored.

In particular, upon determining that the working torque on the motor has increased beyond a threshold value as determined from the working current of the motor 252, a wheel dressing operation can be initiated by the controller 500 in which the diameter of the edge finishing wheel 201 is reduced, thereby reducing the depth of the grooves of the edge finishing wheel. In turn, the contact area between the surface(s) 102 of the glass sheet 100 and the grooves of the edge finishing wheel 201 is decreased, thereby decreasing the tangential force component F-Tangential of the total force F_{Total} acting on the glass sheet 100 due to contact with the edge finishing wheel 201 and increasing the normal force component F_{Normal} of the total force F_{Total} acting on the glass sheet 100, improving the efficacy of the glass edge finishing operation.

Referring to FIGS. 2-5, FIG. 5 is a flow chart 600 of one embodiment of a method of operating the edge finishing apparatus 10. At block 602 the processor 502 of the controller 500 monitors the working torque of the motor 252 by receiving a signal indicative of the working torque on the motor 252 during an edge finishing operation (i.e., when the edge finishing wheel 201 is engaged with the edge 110 of a glass sheet 100). In embodiments, the signal received from the motor 252 may be the operating current of the motor during the edge finishing operation that, as noted herein, corresponds to the torque on the motor 252.

Thereafter, at block 604, the processor 502 of the controller 500 determines if the working torque of the motor 252 is greater than an upper threshold torque value corresponding to a maximum groove depth of the edge finishing wheel 201. In one embodiment, the processor 502 determines if the working torque of the motor 252 is greater than an upper threshold torque value corresponding to a maximum groove depth of the edge finishing wheel 201 by directly comparing the working torque of the motor 252 to the upper threshold torque value. In this embodiment, the upper threshold torque value is an empirically determined constant stored in the memory 504 of the controller 500. The upper threshold torque value corresponds to the working torque on the motor 252 of the edge finishing apparatus 10 when the edge finishing wheel 210 is engaged with the edge 110 of a glass sheet 100 and the grooves 205 of the edge finishing wheel 201 have reached a depth where the efficacy of the edge finishing operation diminishes with increasing depth d of the grooves 205. In embodiments, the value of the upper threshold torque value is determined by the desired edge finish achieved by the edge finishing wheel as a function of the groove depth of the edge finishing wheel. For example, the value of the upper threshold torque may be determined empirically by correlating the groove depth to a desired edge finish quality. If the working torque value of the motor 252 is not greater than the upper threshold torque value, the processor 502 of the controller 500 repeats the method starting at block 602. However, if the working torque value of the motor 252 is greater than the upper threshold torque value, the processor 502 of the controller proceeds to block 606 and initiates a wheel dressing operation as described herein with respect to FIG. 4.

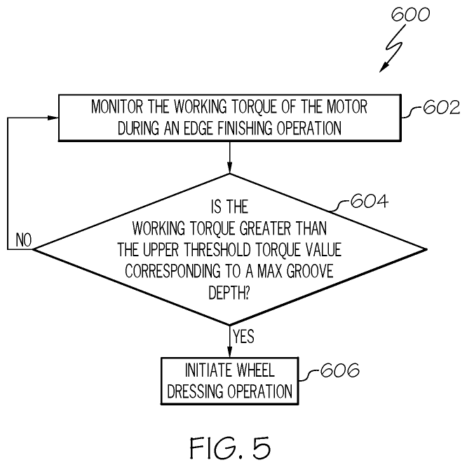

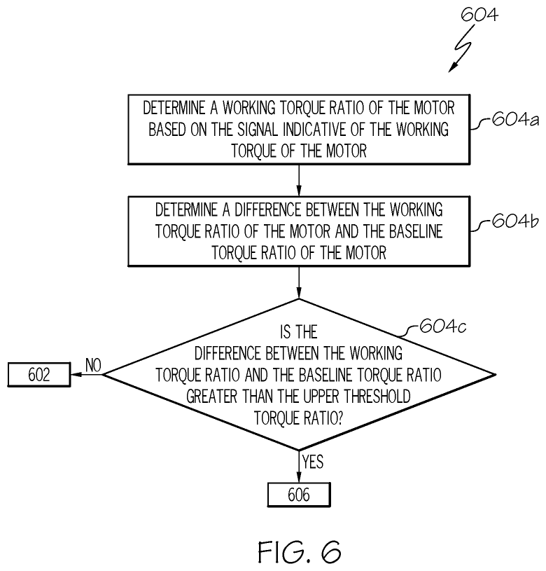

Referring now to FIGS. 5 and 6, an alternative embodiment of block 604 of the flow chart 600 is schematically depicted in FIG. 6. In this embodiment, processor 502 of the controller 500 may utilize torque ratios to determine if the working torque of the motor 252 is greater than an upper threshold torque value corresponding to a maximum groove depth. In this embodiment, the step of determining if the working torque of the motor 252 is greater than an upper threshold torque value corresponding to a maximum groove depth (i.e., block 604 of the flow chart 600) includes the step of determining a working torque ratio of the motor 252 based on the signal indicative of the working torque of the motor 252 at block 604a. In particular, the signal indicative of the working torque of the motor 252 may be the working current of the motor 252 during the edge finishing operation (i.e., the current of the motor when the edge finishing wheel 201 is engaged with the edge 110 of a glass sheet 100). The working torque ratio of the motor 252 is determined by the processor 502 of the controller 500 by dividing the working current of the motor 252, as received by the processor 502, by the maximum current of the motor 252 and multiplying the quotient by 100 to obtain a percentage (i.e., working torque ratio=(working current/maximum current)×100). In embodiments, the maximum current of the motor 252 is the rated current of the motor and is a measureable characteristic of the motor 252, which may be stored in the memory 504 of the controller 500 for the specific edge finishing apparatus 10.

At block 604b, the processor 502 of the controller 500 determines a difference between the working torque ratio of the motor 252 (determined in block 604a) and the baseline torque ratio of the motor 252 (i.e., working torque ratio-baseline torque ratio). The baseline torque ratio may be stored in the memory 504 of the controller 500 or otherwise calculated by the processor 502 of the controller 500 based on values stored in the memory 504 of the controller 500 or values received by the processor 502 of the controller 500. The baseline torque ratio is the baseline current of the motor 252 divided by the maximum current of the motor 252 and multiplied by 100 to obtain a percentage (i.e., baseline torque ratio=(baseline current/maximum current)×100). In this embodiment, the baseline current of the motor 252 is the current of the motor during operation when no load is applied to the edge finishing wheel 201 (i.e., the current through the motor 252 when the edge finishing wheel is not engaged with an edge 110 of a glass sheet 100 during an edge finishing operation). In embodiments, the baseline current of the motor 252 may be a measurable characteristic of the motor 252 of the edge finishing apparatus 10, which may be stored in the memory 504 of the controller 500 for the specific edge finishing apparatus 10. Alternatively, the baseline current of the motor 252 may be measured during operation of the edge finishing apparatus 10 when the edge finishing apparatus 10 is not engaged with the edge 110 of a glass sheet 100. As noted herein, the maximum current of the motor 252 is a measureable characteristic of the motor 252, which may be stored in the memory 504 of the controller 500 for the specific edge finishing apparatus 10.

At block 604c, the difference between the working torque ratio and the baseline torque ratio is then compared to the upper threshold torque value to determine if a wheel dressing operation should be initiated by the controller 500. In this embodiment, the upper threshold torque value is an upper threshold torque ratio corresponding to the maximum groove depth. In particular, the upper threshold torque ratio is an empirically determined constant stored in the memory 504 of the controller 500. For example, the upper threshold torque ratio may correspond to the difference between the working torque ratio and the baseline torque ratio of the motor 252 of the edge finishing apparatus 10. The value of the working torque ratio used to calculate this difference is determined when the edge finishing wheel 210 is engaged with the edge 110 of a glass sheet 100 and the grooves 205 of the edge finishing wheel 201 have reached a depth where the efficacy of the edge finishing operation diminishes with increasing depth d of the grooves 205. In embodiments, the upper threshold torque ratio may be within a range from about 48% to about 52%.

If the difference between the working torque ratio of the motor 252 and the baseline torque ratio of the motor 252 is not greater than the upper threshold torque ratio, the processor 502 of the controller 500 repeats the method starting at block 602 (FIG. 5). However, if the difference between the working torque ratio of the motor 252 and the baseline torque ratio of the motor 252 is greater than the upper threshold torque ratio, the processor 502 of the controller proceeds to block 606 (FIG. 5) and initiates a wheel dressing operation as described herein.

Referring again to FIGS. 2 and 3, in operation, the edge 110 of a glass sheet 100 is engaged with a groove, such as groove 205a, of the edge finishing wheel 201 as the edge finishing wheel 201 is rotated such that the edge 110 of the glass sheet 100 is polished and/or cleaned. During the finishing operation, the glass sheet 100 may be translated or otherwise conveyed along a plane parallel to the X-Y plane of the coordinate axes depicted in FIG. 2 in the +/−Y direction to facilitate polishing and/or cleaning the entire edge 110 of the glass sheet 100. Once the edge 110 of the glass sheet 100 is finished by the edge finishing wheel 201, the edge 110 of the glass sheet 100 is disengaged from the groove 205a and the edge finishing wheel 201 is indexed such that the next subsequent glass sheet is received in the next consecutive groove of the edge finishing wheel 201, in this example groove 205b. In embodiments, the indexing of the edge finishing wheel 201 is achieved by the multi-axis positioning stage 254. Alternatively, instead of indexing the edge finishing wheel 201, the position of the next subsequent glass sheet 100 may be indexed relative to the edge finishing wheel 201 such that an edge of the next subsequent glass sheet is engaged with the next consecutive groove of the edge finishing wheel 201. This cycle of finishing/indexing is repeated for each glass sheet 100 finished with the edge finishing apparatus 10 to reduce edge finishing variability across a population of glass sheets finished with the edge finishing apparatus 10.

While the edges 110 of glass sheets 100 are finished with the glass finishing apparatus 10, the controller 500 of the glass finishing apparatus 10 monitors the working torque of the motor 252 of the edge finishing apparatus 10, as described herein, to determine when to initiate a wheel dressing operation to mitigate the effects of the wear of the edge finishing wheels on the edge finishing process. The implementation of periodic wheel dressing operations based on the working torque of the motor further reduces edge finishing variability across the population of glass sheets finished with the edge finishing apparatus, thereby improving glass sheet quality and consistency, reducing the amount of waste glass and improving manufacturing yields.

Moreover, the implementation of periodic wheel dressing operations based on the working torque of the motor may further extend the service life of the edge finishing wheels by providing consistent groove depth over the life of the edge finishing wheels. In particular, periodic wheel dressing operations based on the working torque of the motor allows shallow grooves to be utilized in the edge finishing wheel that, in turn, allows more grooves to be formed in the edge finishing wheel as the shallow grooves better maintain their structural integrity. More grooves per edge finishing wheel allows for more linear meters of glass to be treated with a single wheel which, in turn, may decrease manufacturing costs.

Accordingly, it should be understood that the edge finishing apparatuses and methods described herein may be used to both improve the quality of glass sheets treated with the edge finishing apparatus and to reduce manufacturing costs of the glass sheets.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A method of finishing edges of glass sheets, the method comprising:
engaging an edge of a glass sheet with a groove of an edge finishing wheel as the edge finishing wheel is rotated with a motor;
monitoring a working current of the motor when the edge finishing wheel is engaged with the edge of the glass sheet, wherein the working current is indicative of a working torque of the motor;
determining if the working torque of the motor is greater than an upper threshold torque value corresponding to a maximum groove depth; and
engaging a blade of a cutting head with an outer diameter of the edge finishing wheel when the working torque of the motor is greater than the upper threshold torque value, thereby shaving material from the outer diameter of the edge finishing wheel and decreasing the working torque of the motor.

2. The method of claim 1, wherein:
the upper threshold torque value is an upper threshold torque ratio corresponding to the maximum groove depth; and
determining if the working torque of the motor is greater than the upper threshold torque ratio comprises:
determining a working torque ratio of the motor, wherein the working torque ratio=(the working current of the motor/a maximum current of the motor)×100;
determining a difference between the working torque ratio and a baseline torque ratio of the motor, wherein the baseline torque ratio=(a baseline current of the motor/the maximum current of the motor)×100; and
comparing the difference between the working torque ratio and the baseline torque ratio to the upper threshold torque ratio.

3. The method of claim 2, wherein the upper threshold torque ratio is within a range from 48% to 52%.

4. The method of claim 1 further comprising directing liquid onto the blade of the cutting head and the edge finishing wheel when the blade of the cutting head is engaged with the outer diameter of the edge finishing wheel.

5. The method of claim 4 further comprising collecting the liquid and debris from the shaving material from the outer diameter of the edge finishing wheel in a collection trough.

6. The method of claim 5, wherein a debris shield is disposed proximate the edge finishing wheel and oriented to direct the liquid and debris projected from the edge finishing wheel into the collection trough.

7. The method of claim 5 further comprising applying vacuum to the collection trough to evacuate the liquid and debris from the collection trough.

8. The method of claim 7 further comprising directing the liquid and debris from the collection trough to a waste recovery bin.

9. The method of claim 1, wherein the edge finishing wheel comprises abrasive particles embedded in a resin matrix.

10. The method of claim 1, wherein the edge finishing wheel comprises a plurality of grooves.

11. The method of claim 10, wherein a depth of the plurality of grooves is greater than or equal to 0.3 mm and less than or equal to 0.6 mm.

12. The method of claim 10, wherein a pitch of the plurality of grooves is less than or equal to 1.5 mm.

13. An edge finishing apparatus for finishing an edge of a glass sheet, the edge finishing apparatus comprising:
a finishing wheel assembly comprising an edge finishing wheel rotatably coupled to a motor, the edge finishing wheel comprising a plurality of grooves for engaging with the edge of the glass sheet;
a wheel dressing assembly comprising a cutting head mechanically coupled to an actuator; and
a controller communicatively coupled to the motor of the finishing wheel assembly and the actuator of the wheel dressing assembly, the controller comprising a processor and a non-transitory memory storing computer readable and executable instructions which, when executed by the processor, cause the processor to:
receive a signal from the motor indicative of a working torque of the motor;
determine if the working torque of the motor is greater than an upper threshold torque value corresponding to a maximum groove depth; and
initiate a wheel dressing operation when the working torque of the motor is greater than the upper threshold torque value, wherein the controller initiates the wheel dressing operation by actuating the actuator of the wheel dressing assembly to engage a blade of the cutting head with the edge finishing wheel.

14. The edge finishing apparatus of claim 13, wherein:
the upper threshold torque value is an upper threshold torque ratio corresponding to the maximum groove depth; and
the processor determines if the working torque of the motor is greater than the upper threshold torque ratio by:
determining a working torque ratio of the motor based on the signal indicative of the working torque of the motor, wherein the working torque ratio=(a working current of the motor/a maximum current of the motor)×100; and
determining a difference between the working torque ratio and a baseline torque ratio of the motor, wherein the baseline torque ratio=(a baseline current of the motor/the maximum current of the motor)×100.

15. The edge finishing apparatus of claim 14, wherein the upper threshold torque ratio is within a range from 48% to 52%.

16. The edge finishing apparatus of claim 13, wherein:
the edge finishing apparatus further comprises a nozzle positioned to direct liquid onto the cutting head and the edge finishing wheel; and
initiating the wheel dressing operation comprises actuating at least one valve operatively associated with the nozzle such that the liquid is directed onto the cutting head and the edge finishing wheel.

17. The edge finishing apparatus of claim 16, further comprising a collection trough disposed below the edge finishing wheel and the cutting head, the collection trough arranged to collect debris and liquid during the wheel dressing operation.

18. The edge finishing apparatus of claim 17, further comprising:
a vacuum system fluidly coupled to the collection trough with a drain line; and
a waste recovery bin coupled to the drain line, wherein initiating the wheel dressing operation comprises actuating the vacuum system fluidly coupled to the collection trough to evacuate debris and liquid from the collection trough to the waste recovery bin.

19. The edge finishing apparatus of claim 17, further comprising a debris shield disposed proximate the edge finishing wheel and oriented to directed liquid and debris projected from the edge finishing wheel during the wheel dressing operation into the collection trough.

20. The edge finishing apparatus of claim 13, wherein:
a depth of the plurality of grooves is greater than or equal to 0.3 mm and less than or equal to 0.6 mm; and
a pitch of the plurality of grooves is less than or equal to 1.5 mm.
